(19) United States
(12) Patent Application Publication
(10) Pub. No.: US 2007/0189329 A1
(43) Pub. Date: Aug. 16, 2007

(54) System for combining networks of different addressing schemes

(75) Inventor: Mikael Latvala, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/472,522

(22) Filed: Jun. 22, 2006

(30) Foreign Application Priority Data
Feb. 14, 2006 (EP) 06 002 951.9

(51) Int. Cl. H04J 3/16

(52) U.S. Cl. 370/466; 370/392

(57) ABSTRACT

A system for combining networks of different addressing schemes comprises the incorporation of at least one interstitial function between at least one address realm of the one network and at least one address realm of another network for mapping an address between the different addressing schemes. Preferably, the interstitial function uses a public address realm as root address realm wherein the address realms are organized in a hierarchical manner and the address realm without any parents is the root address realm. The location of each node within the combined networks may be expressed as a list of individual realm specific addresses from the different address realms given in a specified order, wherein said listed addresses together form a common universal address of said node.

### FIELD OF THE INVENTION

The present invention relates to network architecture domain technology and in particular a system for combining networks of different addressing schemes.

### BACKGROUND OF THE INVENTION

The dominant communication paradigm in the internet has been the client-server model, where there are two nodes and one of the nodes, the client node, initiates a procedure which shall either fail for some reason or lead to a working communication abstraction (e.g. TCP connection or SCTP association) between the server node and the client node. This model has sustained the changes in the internet such as introduction of NATs (network address translators) mainly because server nodes are typically located in the “public” internet where every node has a public IP (internet protocol) address.

The recent introduction of P2P (peer-to-peer) applications, however, has changed this and made NAT traversal as one of those hard problems that people are trying to solve. In this new situation, nodes such as mobile phones or personal computers which have earlier had the role of client nodes need to act also as server nodes, which accept incoming connection requests from other nodes.

Unfortunately nodes behind NAT boxes cannot function as servers because NAT boxes hide their presence in the internet. A node behind a NAT is assigned with a private IP address which is valid only within the private address realm from which the address has been allocated. Because these addresses are not visible or useable in other address realms, especially in the public address realm, hosts in other address realms cannot reach nodes behind NAT boxes unless some type of a hole is punched in the NAT box and this hole is advertised to hosts in other address realms.

Another problem in the internet is the division of the network into multiple address realms. This does not only apply to private IPv4 address realms for which NAT was invented but also to the IPv6 address realm which is going to coexist with private and the public IPv4 address realms. Internet does not have currently a common solution which would allow data packets to traverse from one address realm to another one. The lack of common mechanism means that each boundary point has to have its own mechanism how to translate addresses valid in one realm to a format which is valid in another realm. NATs provide a mechanism how the mapping is done between public and private IPv4 address realms. However, even NAT boxes do not share the same translation mechanism which further complicates the design of NAT traversal solutions.

FIG. 1 schematically shows that the internet is portioned into incompatible address realms. As mentioned above, currently these realms are the public IPv4 realm, the public IPv6 realm and private IPv4 realms. However, future may bring new address realms (such as ones used in sensor networks) which need to be attached to the internet or new address realms created for other planets. There are also good arguments which validate the need to converge other existing address realms such as E1.64, Ethernet, or ATM (asynchronous transfer node) End System Address with the existing IP based realms. Therefore, the internet should have a common future-proof mechanism, which makes it possible to add new address realms into the internet. This obviously contrasts strictly with the current axiom that IP layer is the thin waist in the hour glass model, which combines networks with differing technologies into the “network of networks”, i.e. the internet.

### SUMMARY OF THE INVENTION

An object of the present invention is to provide a mechanism for combining networks of different addressing schemes, i.e. address realms, into a new so-called Internet Ecosystem.

Further, it is an object of the present invention to provide a mechanism which allows a node in an ambient network to send a data packet to another node in another ambient network if both ambient networks have assigned locators for nodes from different address realms.

In order to achieve the above and further objects, according to the present invention there is provided a system for combining networks of different addressing schemes, comprising the incorporation of at least one interstitial function between at least one address realm of the one network and at least one address realm of another network for mapping an address between the different addressing schemes.

Advantageous embodiments are defined in the dependent claims.

The present invention proposes a new concept which defines a so-called realm aware source routing and is used as a mechanism to combine networks with different address schemes, i.e. address realms, into a new so-called Internet Ecosystem (also referred to as interplanetary internet, a network of regional internets). According to the teaching of the present invention, there lies an interstitial function (IF) between the different address realms which carries out an address mapping between the different addressing schemes.

The concept of the present invention makes it possible that two nodes in different address realms can communicate with each other as long as these address realms are connected to each other directly or indirectly wherein it is to be ensured that addresses in the destination and source address field are always valid in the address realm to which a data packet is forwarded.

Further, the concept of the present invention meets the current address depletion problem in the public IPv4 realm, because a node in the Internet does not have anymore to be assigned to an address from the public IPv4 address space so that other peer nodes could reach the node.

In particular, unlike the known concepts which are designed only for IPv4 realms, the concept of the present invention allows the nodes in IPv6 realms to easily communicate with nodes in IPv4 realms. It is also possible to attach network systems with totally different addressing mechanisms, such as Ethernet, SS7 or ATM, to be part of the internet. Moreover, the concept of the present invention even allows multiple overlapping IPv4 realms to coexist. Due to the concept of the present invention, DNS can be used to locate a node in any address realm. However, the invention does not exclude other possible name resolution mechanisms.

Due to the concept of the present invention, there is no need to introduce a new node identity (ID) as done e.g. in HIP, I3 or IPNL solutions. Unlike the traditional NAT traversal solutions which assume that there is some third party in the public IPv4 realm which is used in the whole punching process, the concept of the present invention does not assume that any such element is present in the public IPv4 domain.

Further, due to the concept of the present invention the port integrity is maintained. This means that IF do not have to perform port mapping unlike NAT boxes.

Nodes provided with the interstitial function are stateless which results in a considerable reduction of development costs. This is in strict contrast to the NAT nodes structure.

Furthermore, the concept of the present invention eliminates the need to create tunnels which are used in the current internet to carry data packets through a “transit” address realm.

Unlike the known concepts, the present invention does not result in essentially changes to socket API.

Finally, the concept of the present invention follows one of the principle design guides in the internet which mandates that a network should be kept as simple as possible.

In the context of the present invention, it should be noted that the term “realm” refers to an addressing scheme with some administrative boundaries wherein each address realm has an address space from which addresses are allocated, and its own addressing allocation mechanisms and policies which are independent from other address realms.

### BRIEF DESCRIPTION OF THE DRAWINGS

In the following, the present invention will be described in greater detail based on preferred embodiments with reference to the accompanying drawings in which:

FIG. 1 shows a schematic example of the portioning of the internet into several incompatible address realms;

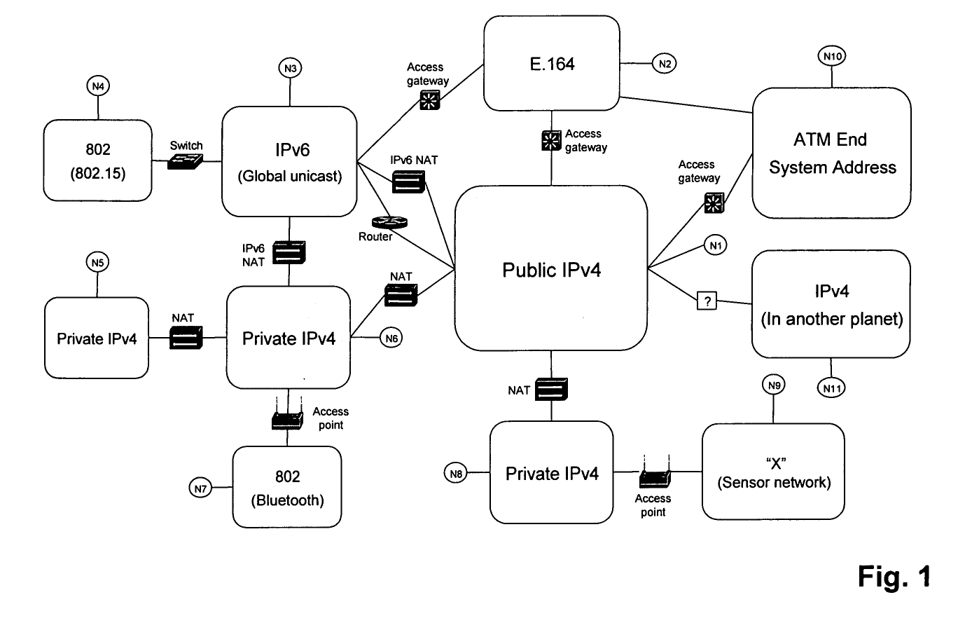

FIG. 2 schematically shows the hierarchy of realm aware source routing according to a preferred embodiment of the present invention;

FIG. 3 schematically shows a first example of a universal address format;

FIG. 4 schematically shows a second example of a universal address format;

FIG. 5 schematically shows an example of a private IPv4—root realm—private IPv4 scenario of the realm aware source routing according to a preferred embodiment of the present invention;

FIG. 6 is a schematic flow diagram of a sender logic according to a preferred embodiment of the present invention;

FIG. 7 schematically shows an example of a universal address option in an IPv4 data packet created and sent by a sender;

FIG. 8 schematically shows an example of the format of a destination universal address option in an IPv4 header;

FIG. 9 schematically shows an interstitial function logic according to a preferred embodiment of the present invention;

FIG. 10 shows an example of the format of a source universal address option in an IPv4 header;

FIG. 11 schematically shows an example of a universal address option in a received IPv4 data packet;

FIG. 12 schematically shows a private IPv4—private IPv4—root realm scenario of the realm aware source routing according to a preferred embodiment of the present invention;

FIG. 13 schematically shows a private IPv4—root realm—IPv6 scenario of the realm aware source routing according to a preferred embodiment of the present invention; and

FIG. 14 schematically shows a MAC—IPv6—root realm scenario of the realm aware source routing according to a preferred embodiment of the present invention.

### DESCRIPTION OF THE PREFERRED EMBODIMENTS

A realm aware source routing is used as mechanism to combine networks with differing address schemes, i.e. address realms, into a new Internet Ecosystem (also referred to as interplanetary internet, a network of regional internets). In the present concept, there lies an interstitial function (IF) between address realms. IFs are in charge of understanding which addresses are valid in which realm and insert a valid address, which is part of a universal address (UA), in the proper IPv4 header field or in some other functionally equivalent header as specified later.

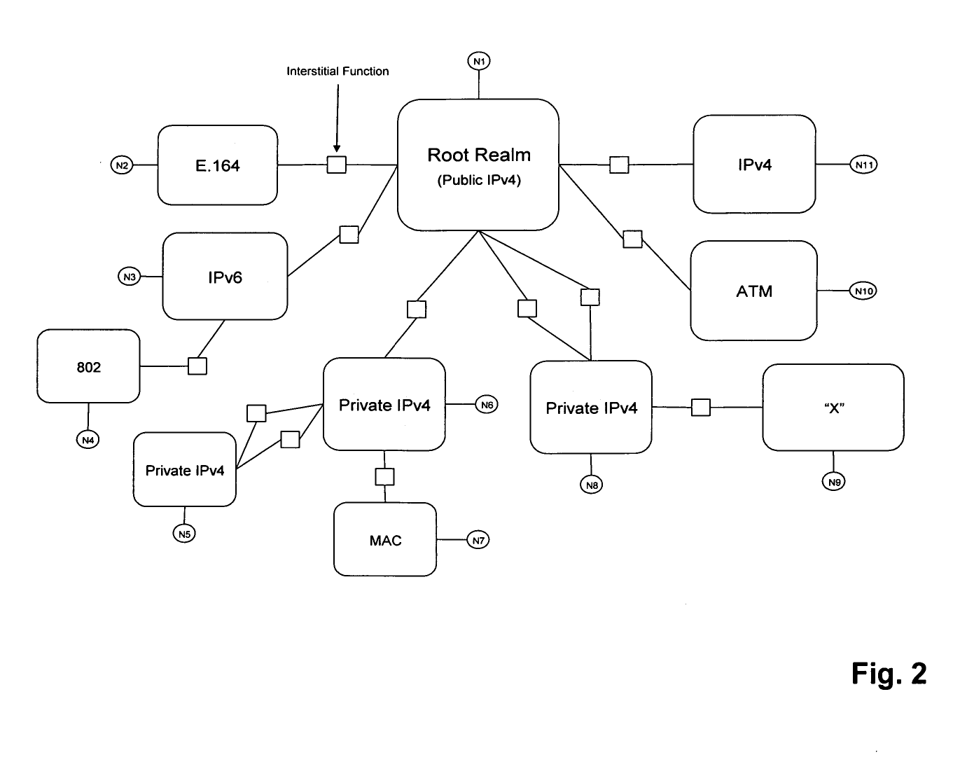

In the centre of the new internet ecosystem is a root realm which is a public IPv4 address realm, previously referred to as internet. As shown in FIG. 2, the address realms are organized in a hierarchical manner, where the root realm is the one without any parents. Any data packet exchanged by two nodes in different address realms R1 and R2 must traverse through the root realm.

The root realm has a special meaning in the realm aware source routing (RASR) concept because each node's location, i.e. Universal Address (UA), in the new internet ecosystem is expressed as a list of addresses from different address realms, starting with the address from the root address realm and ending with the address from the address realm to which the node is attached. RASR assumes that the current network layer headers such as IPv4 and IPv6 or any functionally equivalent header are adequate and therefore require that only two new option fields are introduced in the headers.

A UA of a Node N can be described as a set of addresses
UA_{NodeN}={a₁, a₂, . . . , aₙ}
wherein a₁ is the address of an IF which is connected to the root address realm and through which packets destined to Node N must traverse. The last address aₙ is the address allocated to the address realm to which the node is connected. The addresses between the first and the last address belong to IFs that are between the root address realm's IF and Node N.

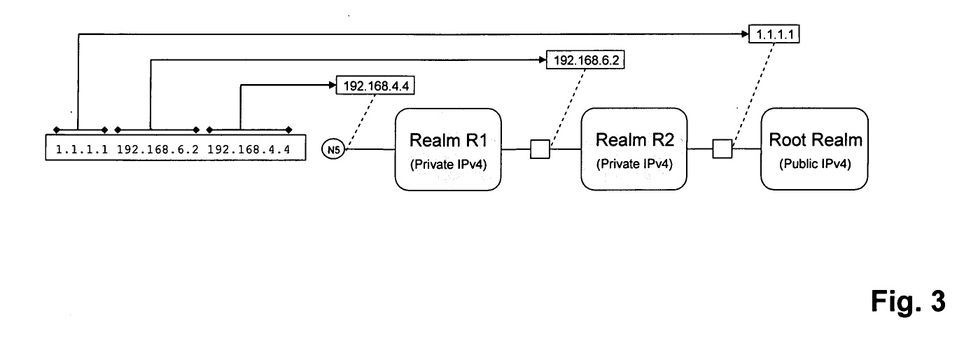

For example, Node N5 in a private IPv4 address realm, which is connected to another private IPv4 realm which is then connected to the root realm, would have a UA of the form
UA_{N5}={public IPv4 address, private IPv4 address, private IPv4 address}
as shown in FIG. 3.

The last address, i.e. “192.168.4.4” in the example of FIG. 3, is the address that has been assigned to Node N5 in the address realm R1 (cf. FIG. 3). The other addresses in the UA are addresses of IFs nodes which translate and forward packets between address realms.

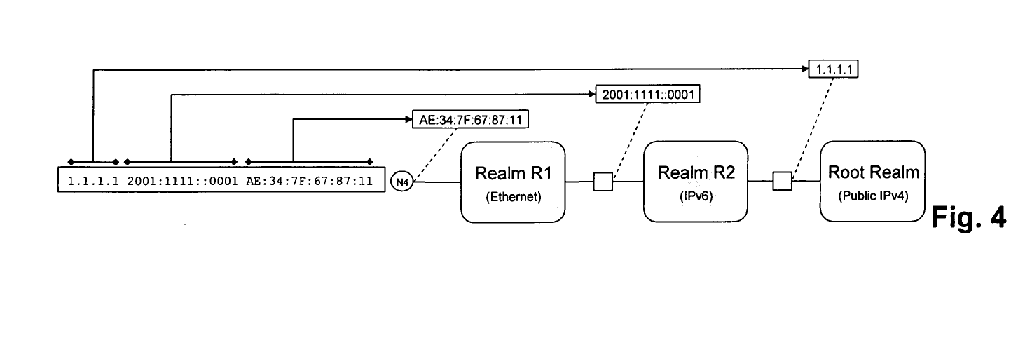

In another example Node N4 is located in a sensor network which uses a MAC (message authentication code) addressing scheme and is connected to the public IPv6 address realm, which is then connected to the root realm, would have a UA with the format
UA_{N}₄={public IPv4 address, public IPv6 address, MAC address}
as shown in FIG. 4.

A UA address of a node which is connected to the root realm is an address which is assigned to the node from the public IPv4 address space. E.g. Node N1 would have a UA
UA_{N1}={public IPv4 address}
As IF nodes lying between address realms are aware of the address format used in each address realm, there is no need to embed the address length information into the UA.

All individual realm specific addresses which together form an UA may be listed in a predetermined right order, i.e. starting from the root realm address and ending at the address that the node has in the address realm to which it is currently connected to.

The RASR concept does not only allow nodes in a heterogeneous communication ecosystem to communicate with each other, but it also reduces the complexity of IF, because instead of having to store address translation states as NAT boxes do IF has to only change the order of addresses in the IP header. The statelessness of an IF can be easily complemented with additional security functionality (e.g. firewall) without having to be concerned that there would be conflicting states in IF.

Furthermore, RASR removes the need to create tunnels that are used in the current internet to carry data packets through a “transit” address realm.

RASR also makes it possible to have two or more address realms with an identical address space while allowing nodes in these address realms to communicate with each other. Nodes in different realms could even have overlapping addresses on an address realm level.

RASR logic also ensures that a source address field is always filled with an address from the address realm through which the packet is going to traverse. This prevents the scenario where routers in a given address realm perform ingress filtering and thus discard packets with an invalid source address. RASR logic further ascertains that RASR modifications are transparent to forwarding entities in any given address realm, because the IPv4 or any functionally equivalent header, which carries RASR addresses, is augmented only with one or two optional UA options. The address fields of IPv4 or any functionally equivalent header are kept unchanged.

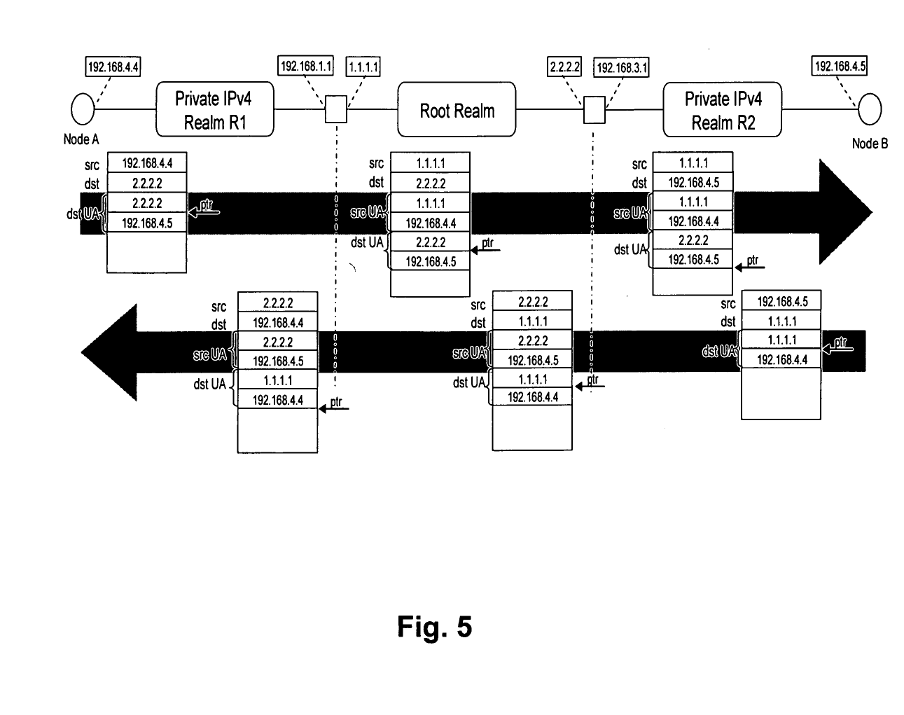

FIG. 5 illustrates an example where Node A connected to an address realm R1 wants to communicate with Node B in address realm R2. R1 and R2 are not directly connected to each other but instead are each connected to a root realm.

The scenario starts with Node A wanting to know Node B's UA address. As this is usually done through a DNS query (typically via a system call “gethostbyname( )”) there would have to be a new resource record in DNS, which is used to store the binding between Node B's FQDN (fully qualified domain name) and the UA. The following table shows how this binding could be stored in DNS input files:
A in UA: “1.1.1.1.192.168.4.4”
B in UA: “2.2.2.2.192.168.4.5”

Of course, Node A can find Node B's UA address by means of some other mechanisms. For example, there could be a non-global directory service for selected address realms which stores bindings between an identifier and a locator of the nodes in a data base.

Next a “gethostbyname( )” call returns a structure which includes a 64bit long UA address of Node B. As most of the applications are not interested in the length of the destination address, return of an UA instead of an IPv4 address would not require any changes to these applications.

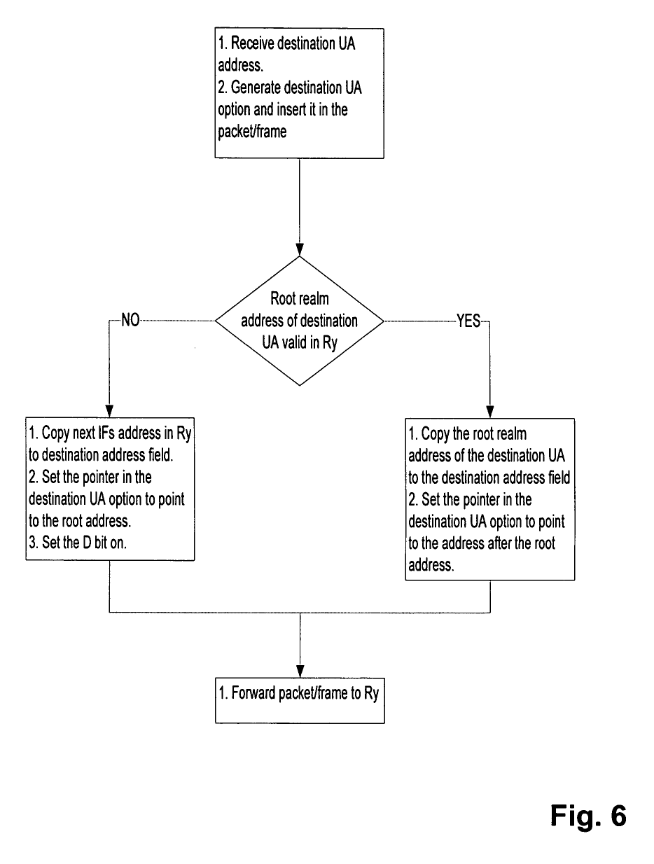

The application would give this address to the underlying TCP/IP stack when calling a “connect ( )” function. If the node did not have a TCP/IP stack, any other functionally equivalent protocol stack would receive the UA and process the address as shown in FIG. 6.

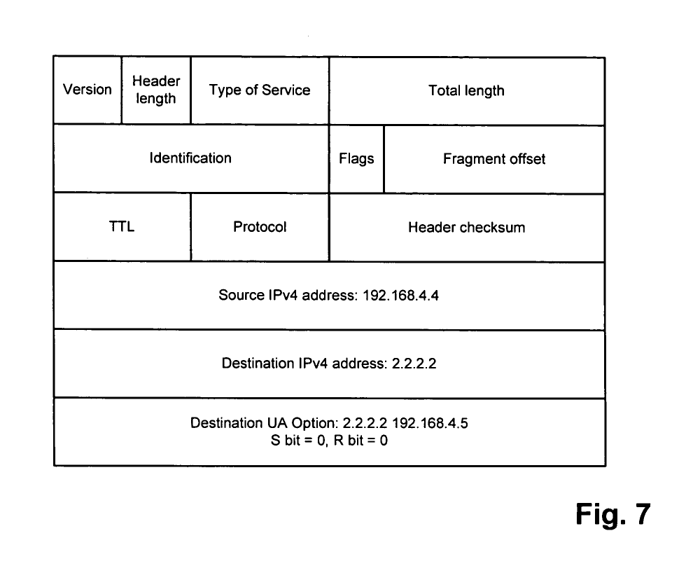

After having received the UA, the TCP/IP stack would form a valid IPv4 header. As mentioned earlier the only modification that is required to the current IPv4 header format is the allocation of a space in the IP header where the UA formation is stored. This would be done by introducing two new options, one for a destination UA and one for a source UA. In this example, the TCP/IP stack would create an IP header with a destination UA option as shown in FIG. 7.

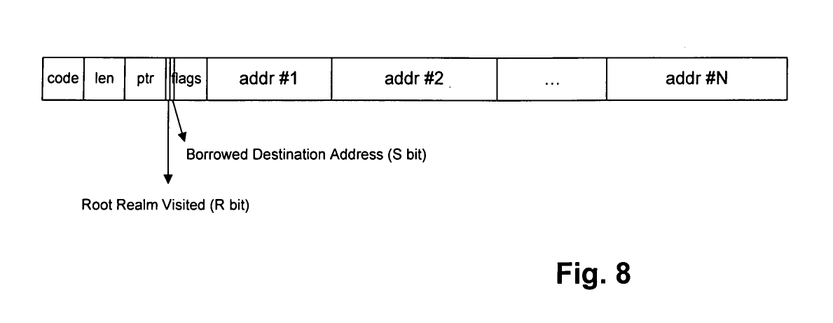

An example of the format of the destination UA option in the IPv4 header is shown in FIG. 8. The format of this destination UA option which is similar to an IP source routing option includes the fields “code”, “len”, “ptr” and “flags” as well as the destination address fields. The “code” field specifies the type of the IP option. The field “len” gives the total number of bytes of the destination UA option. The field “ptr” represents a pointer to the next address which is used by an IF when determining what kind of an address should be copied into the destination address field. The “flags” field includes two values being an “R” bit and a “S” bit, wherein the “R” bit is provided to mark whether the data packet has traversed the root realm, and the “S” bit is provided to mark whether the source address field has an address which is not from a source UA, but instead borrowed from the address of the IF which sent the packet.

Next the TCP/IP stack of Node A would send the data packet to a router in an address realm to which Node A is connected. Routing within R1 would happen according to the rules specified by R1. At one point the data packet would arrive at an IF node which lies between R1 and R2. The fact that the data packet would arrive at the IF node between R1 and the root realm assumes that all the data packets carrying a public IPv4 destination address are routed towards to the root realm in a private IPv4 realm.

In case the first address in the UA, i.e. the address from the root realm, could not be used in the destination address field, the address of an IF which is the receiving IF would have to be inserted into the respective destination address field. This receiving IF is connected to the same realm as the sending IF and thus has at least one address from the same address space. The sending IF or host marks this event by turning on the S bit in the source UA option as shown in FIG. 6.

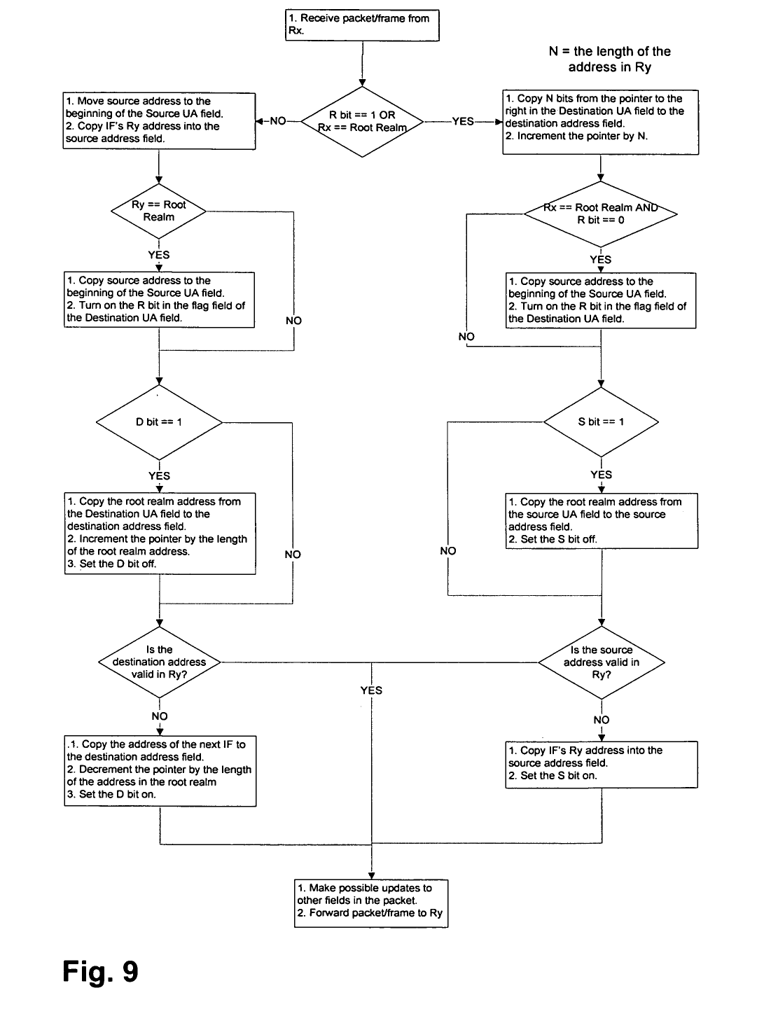

The IF node has a logic shown in FIG. 9, and any IF shall process the data packet accordingly. At each junction between address realms, IF would perform a header modification process as specified in FIG. 9.

The IF logic has been divided into two parts. The first one relates to the data packet modifications that are done before the data packet reaches the root realm (left hand side of FIG. 9). The second part relates to the packet modifications that are done after the packet has reached the root realm (right hand side of FIG. 9). The logic also ensures that, if a data packet has to traverse through an address realm which does not accept the current source or destination address as a valid address, the IF uses its own address as a source address or the next IF's (along the path which the packet must traverse to reach the final destination) address as a destination address.

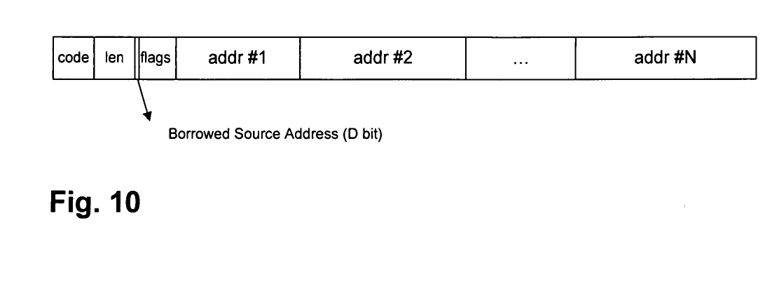

The IFs also start building the source UA in the source UA option so that the node which receives the data packet can send back a reply data packet to the correct node. The source UA option in the IPv4 header is very similar to the destination UA option. The only two differences are that there is no need for the pointer field and “R” bit is not needed in the “flags” field. The “flags” filed only includes one value being a D bit which marks the event when a sending IF could not use the root address of the destination UA in the destination address field and had to replace the address in the destination address field by the receiving IF's address. An example of such a source UA option is shown in FIG. 10.

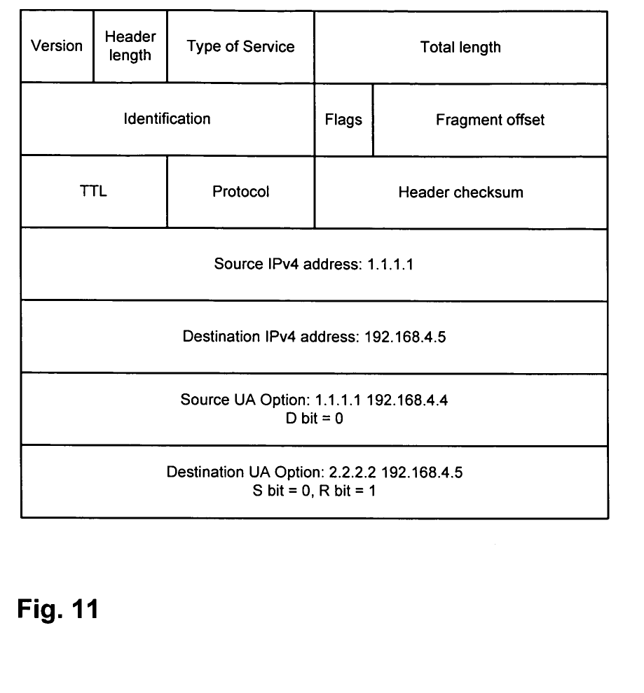

Eventually, the data packet reaches Node B. In this example, the TCP/IP stack in Node B receives the data packet having an IP header as shown in FIG. 11.

Node B's TCP/IP stack or any functionally equivalent protocol stack would pass the payload to the upper transport layer. Node B's receiving protocol stack could determine what is the address of Node A which has sent the data packet by inspecting the source UA option. Since the interstitial functions between Node A and the root realm have inserted their proper address to the source UA option, the source UA option contains a valid UA starting with an address from a root realm. A RASR compliant transport layer would take into account the UA of the sender (“1.1.1.1 192.168.4.4”) when creating a connection state.

The TCP/IP stack which is not RASR compliant would create a connection state using the source and destination addresses “192.168.3.1” and “192.168.4.5”. This would work as long as no two nodes outside of R3 using the same port number would not send the connection initiation packet to the same port number in Node B. If this did happen, then only the first connection would be accepted as the second connection would look identical to the first one.

Typically, the connection establishment procedure requires a 3-way handshake, and thus Node B's TCP/IP stack would have to send a reply back to Node A. If the TCP/IP stack were not RASR compliant, it would use only “192.168.3.1” as destination address. As this is not Node A's address, the data packet would never reach Node A and thus cause a connection timeout and subsequent connection termination, unless at least an IF were implemented with a NAT fallback mechanism, which would make the IF act like a NAT in case the receiving host is not RASR capable.

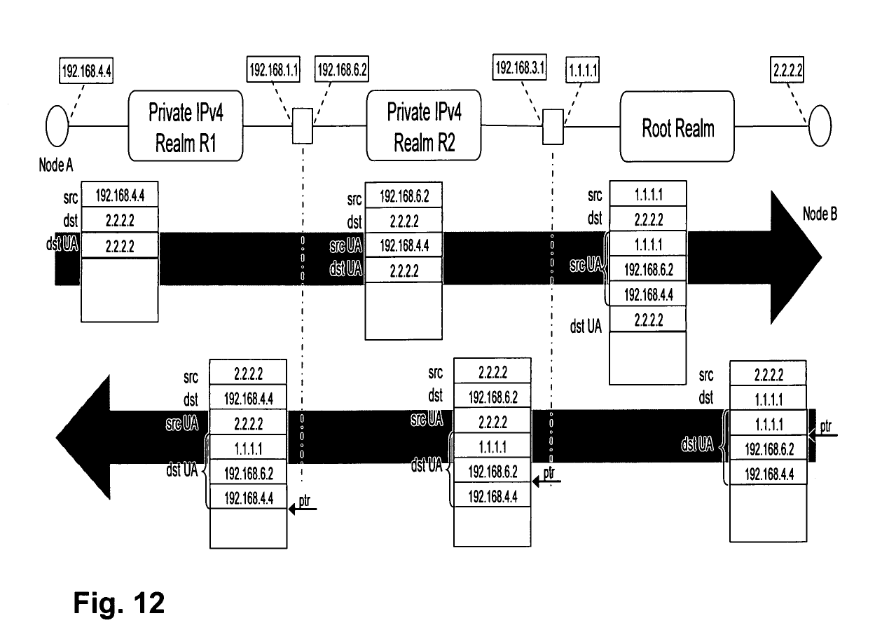

FIG. 12 illustrates another example, wherein Node A lies behind two private IPv4 address realms, and shows how the IFs modify the IP header on its way to Node B and on its way back from Node B to Node A.

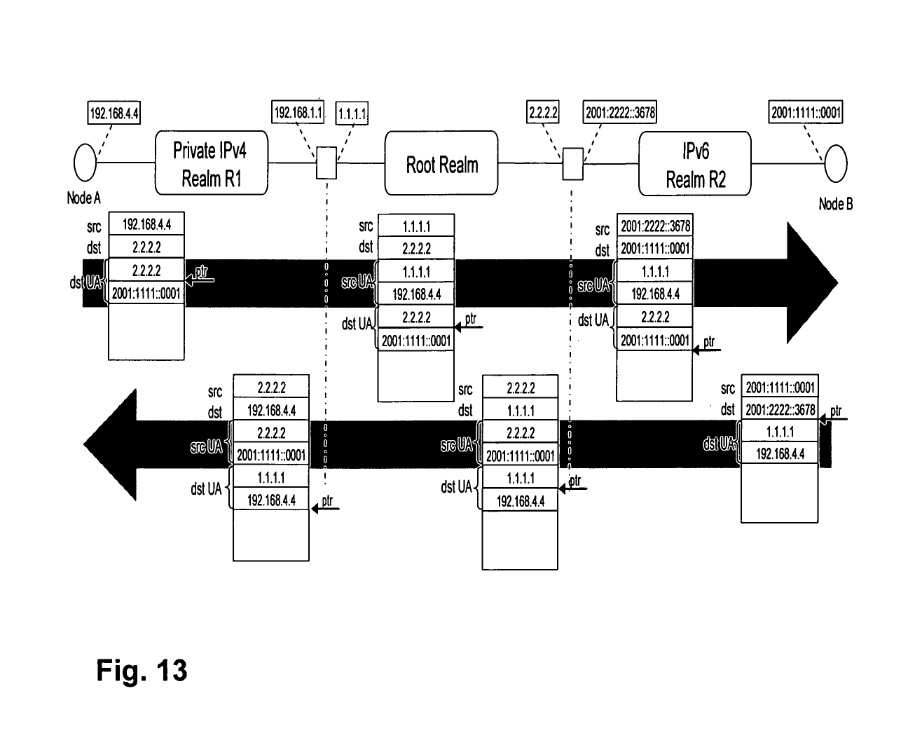

FIG. 13 illustrates a further example, wherein a node in a private IPv4 address realm communicates with a node in an IPv6 address realm.

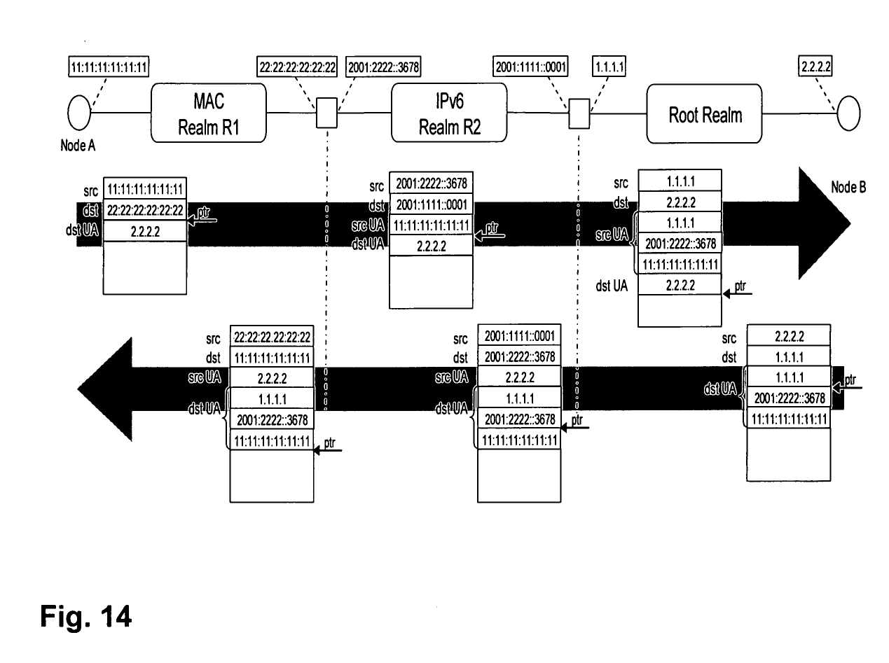

FIG. 14 illustrates still another example, wherein a node in a MAC address realm communicates with a node in the root address realm via an IPv6 address realm.

As given by the above description of preferred embodiments, address realms are organized in a hierarchical manner where the current internet realm, i.e. public IPv4, is the root realm which does not have any parents. The hierarchy is a tree with or without loops. In RASR hierarchy there can be, however, only a singly type of loop. This loop is formed when two address realms are connected to each other through two or more IFs. For example, in FIG. 2 the address realm to which Node N5 is connected has two IFs which connect it to the address realm to which Node N6 is connected. This type of a loop can be used to load balance the traffic if a single IF is in danger of becoming a bottleneck. It also provide higher fault tolerance against IF failures.

The IFs should ensure that in case there are loops between two realms the source UA is kept the same for any single host. Otherwise TCP/IP implementations, which identify connection abstractions using the traditional quintuple <source address, destination address, source port, destination port, protocol>, could not ensure that connections remain operational when the source UA changes.

This means, that an IF which creates the source UA by adding its address to it, must have common any cast address together with the adjoining IFs which all reside between the two same address realms, and use this address when adding an address to a source UA.

Or, the IFs must ensure that data packets transmitted by a node traverse always the same path to the root address realm. As this choice is clearly inferior in terms of fault tolerance, the use of anycast address is a preferred method.

The universal addresses (UA) consist of addresses from one or more realms and are each formed by that the first address (counting from left) in the UA is an address from the root realm, the following addresses in the UA are addresses of IFs connected to realms which the data packets must traverse, and the last address in the UA is the address from the realm to which the node is currently attached. Further, the UA has always at least one address, i.e. a public IPv4 address. Finally, the UA does not need to embed the length of an address of some realm as IFs know by default which is the length of the address of a realm to which it is connected. IF are stateless as all the information needed to update the source and/or destination address fields are always carried in the packet. Two new options/extensions are introduced into IPv4/IPv6 headers which are used to carry source and/or destination UA options needed by the IF to update the source/destination fields with correct addresses. These new options carry all the necessary information so that two or more nodes can communicate with each other regardless in which address realm they are located. Finally, a new resource record can be created in the DNS which allows nodes in different address realms to contact each other by their logical name (i.e. fully qualified domain name).

As it further becomes clear from the above description of preferred embodiments, the RASR makes it possible that nodes in two address realms which have identical address space can communicate with each other by ensuring that the addresses in the destination and source address field are always valid in the address realm to which a data packet is forwarded.

It is noted that the present invention is not restricted to the particular features of the preferred embodiments, but can be varied within the scope of the attached claims.

1. A method for combining networks of different addressing schemes, comprising: incorporating at least one interstitial function between at least one first address realm of a first network and at least one second address realm of a second network for mapping an address between the different addressing schemes.

2. The method according to claim 1, wherein said incorporating step comprises incorporating the interstitial function to determine which addresses are valid in which address realm, said determining comprising inserting a valid address into a data field.

3. The method according to claim 2, wherein said inserting further comprises inserting a valid address into a header.

4. The method according to claim 3, wherein inserting further comprises providing at least one option data fields in the header, the option data fields being u used to carry source or destination address options, which are needed by the interstitial function to update source or destination fields of the header with correct addresses.

5. The method according to claim 1, further comprising positioning at least one node having the at least one interstitial function between the at least one first and second address realms.

6. The method according to claim 1, further comprising the interstitial function using a public address realm as a root address realm.

7. The method according to claim 6, further comprising organizing the at least one first and second address realms in a hierarchical manner, and the at least one first and second address realm without any parents is the root address realm.

8. The method according to claim 6, comprising incorporating at least one sending interstitial function and at least one receiving interstitial function, wherein the sending and receiving interstitial functions are associated with a same root address realm.

9. The method according to claim 6, wherein, if a data packet has to traverse through an address realm which does not accept the current source or destination address as a valid address, the interstitial function uses its own address as a source address or the address of a next interstitial function, along a path that the data packet must traverse to reach a final destination, as a destination address.

10. The method according to claim 6, wherein any data packet exchanged between at least two nodes in different address realms are traversed through the root address realm.

11. The method according to claim 6, wherein a location of each node within the combined networks is expressed as a list of individual realm specific addresses from different address realms given in a specified order, wherein said list of realm specific addresses together form a common universal address of said node.

12. The method according to claim 11, wherein said list of realm specific addresses starts with an address from the root address realm, followed by an address of at least one interstitial function node connected to address realms that the data packet traverses, and ends with an address from an address realm to which a node is currently connected.

13. A system for combining networks of different addressing schemes, comprising incorporation means for incorporating at least one interstitial function between at least one first address realm of the one network and at least one second address realm of a second network for mapping an address between the different addressing schemes.

14. The system according to claim 13, wherein said interstitial function determines which addresses are valid in which address realm, and as a result, a valid address is inserted into a data field.

15. The system according to claim 13, wherein said data field is a field of a header.

16. The system according to claim 15, wherein at least one option data field is provided in the header, the option data field being used to carry source or destination address options, which are needed by the interstitial function to update source or destination fields of the header with correct addresses.

17. The system according to claim 13, comprising at least one node having the at least one interstitial function that is positioned between the address realms.

18. The system according to claim 17, wherein the at least one interstitial function comprises at least one sending interstitial function and at least one receiving interstitial function, wherein the sending and receiving interstitial functions are associated with the same route address realm.

19. The system according to claim 17, wherein if a data packet has to traverse through an address realm which does not accept the current source or destination address as a valid address, the interstitial function uses its own address as a source address or the address of a next interstitial function, along the path which the data packet must traverse to reach the final destination, as a destination address.

20. The system according to claim 13, wherein the location of each node within the combined networks is expressed as a list of individual realm specific addresses from the different address realms given in a specified order, wherein said listed addresses together form a common universal address of said node.

21. The system according to claim 20, wherein said list of addresses starts with an address from the root address realm, followed by an address of at least one interstitial function node connected to address realms which the data packet traverses, and ends with an address from the address realm to which the node is currently connected

22. A system for combining networks of different addressing schemes, comprising:
a first network positioned in a first realm using a first addressing scheme;
a second network positioned in a second realm and using a second addressing scheme, the second addressing scheme being different from the first addressing scheme; a root realm positioned between the first network and the second network and being in communication with both the first and second network such that any communication between the first and second network travels through the root realm;
a first interstitial function node positioned between the first realm and the root realm; and
a second interstitial function node positioned between the second realm and the root realm,
wherein the first and second interstitial function nodes are configured to perform a data packet header modification process on data packets traveling between the first network and the second network.

23. The system for combining networks of different addressing schemes of claim 22, wherein the first interstitial function node is configured to modify a packet header before the packet reaches the root realm, and wherein the second interstitial function node is configured to modify the packet header after the packet has traveled through the root realm.

24. The system for combining networks of different addressing schemes of claim 22, wherein the first and second interstitial function nodes modify the data packet header to include a source or destination address that is associated with the first or second interstitial function node, the source or destination address of the first or second interstitial function node being compatible with an address protocol of a network through which the data packet must traverse.

25. A system for combining networks of different addressing schemes, comprising:
a first network positioned in a first realm using a first addressing scheme;
a second network positioned in a second realm and using a second addressing scheme, the second addressing scheme being different from the first addressing scheme;
a root realm means positioned between the first network and the second network and being in communication with both the first and second network for communicating between the first and second networks;
a first interstitial function node means positioned between the first realm and the root realm means; and
a second interstitial function node means positioned between the second realm and the root realm means,
wherein the first and second interstitial function node means are configured to perform a data packet header modification process on data packets traveling between the first network and the second network.

26. A device adapted to be positioned between at least one first address realm of a first network using a first addressing scheme and at least one second address realm of a second network using a second addressing scheme, the second addressing scheme being different from the first addressing scheme, and comprising at least one interstitial function for mapping an address between the different addressing schemes.

27. The device according to claim 26, wherein said interstitial function determines which addresses are valid in which address realm, and as a result, a valid address is inserted into a data field.

28. The device according to claim 26, wherein said data field is a field of a header.

29. The device according to claim 28, wherein at least one option data field is provided in the header, the option data field being used to carry source or destination address options, which are needed by the interstitial function to update source or destination fields of the header with correct addresses.

30. The device according to claim 26, wherein the at least one interstitial function comprises at least one sending interstitial function and at least one receiving interstitial function, wherein the sending and receiving interstitial functions are associated with the same route address realm.

31. The device according to claim 26, wherein if a data packet has to traverse through an address realm which does not accept the current source or destination address as a valid address, the interstitial function uses its own address as a source address or the address of a next interstitial function, along the path which the data packet must traverse to reach the final destination, as a destination address.

32. The device according to claim 26, wherein the at least one interstitial function performs a data packet header modification process on data packets traveling between the first network and the second network.

33. The device according to claim 32, which is adapted to be positioned between the first address realm and a route realm positioned between the first network and the second network and being in communication with both the first and second network such that any communication between the first and second network travels through the route realm, wherein the interstitial function modifies the data packet header before the data packet reaches the route realm.

34. The device according to claim 32, which is adapted to be positioned between the second address realm of the second network and a route realm positioned between the first network and the second network and being in communication with both the first and second network such that any communication between the first and second network travels through the route realm, wherein the interstitial function modifies the data packet header after the data packet has traveled through the route realm.

35. The device according to claim 33 or 34 wherein the at least one interstitial function modifies the data packet header to include a source or destination address that is associated with the at least one interstitial function, the source or destination address of the at least one interstitial function being compatible with an address protocol of a network through which the data packet must traverse.

36. The device according to claim 26, wherein its location between the networks is expressed as a list of individual realm specific addresses from the different address realms given in a specified order, wherein said listed addresses together form a common universal address of said node.

37. The system according to claim 36, wherein said list of addresses starts with an address from the root address realm, followed by an address of at least one interstitial function node connected to address realms which the data packet traverses, and ends with an address from the address realm to which the node is currently connected

38. A computer program for carrying out a method for combining networks of different addressing schemes, comprising: incorporating at least one interstitial function between at least one first address realm of a first network and at least one second address realm of a second network for mapping an address between the different addressing schemes.

39. The computer program according to claim 38, wherein said incorporating step comprises incorporating the interstitial function to determine which addresses are valid in which address realm, said determining comprising inserting a valid address into a data field.

40. The computer program according to claim 39, wherein said inserting further comprises inserting a valid address into a header.

41. The computer program according to claim 40, wherein inserting further comprises providing at least one option data fields in the header, the option data fields being used to carry source or destination address options, which are needed by the interstitial function to update source or destination fields of the header with correct addresses.

42. The computer program according to claim 38, further comprising positioning at least one node having the at least one interstitial function between the at least one first and second address realms.

43. The computer program according to claim 38, further comprising the interstitial function using a public address realm as a root address realm.

44. The computer program according to claim43, further comprising organizing the at least one first and second address realms in a hierarchical manner, and the at least one first and second address realm without any parents is the root address realm.

45. The computer program according to claim 43, comprising incorporating at least one sending interstitial function and at least one receiving interstitial function, wherein the sending and receiving interstitial functions are associated with a same root address realm.

46. The computer program according to claim 43, wherein, if a data packet has to traverse through an address realm which does not accept the current source or destination address as a valid address, the interstitial function uses its own address as a source address or the address of a next interstitial function, along a path that the data packet must traverse to reach a final destination, as a destination address.

47. The computer program according to claim 43, wherein any data packet exchanged between at least two nodes in different address realms are traversed through the root address realm.

48. The computer program according to claim 43, wherein a location of each node within the combined networks is expressed as a list of individual realm specific addresses from different address realms given in a specified order, wherein said list of realm specific addresses together form a common universal address of said node.

49. The method according to claim 48, wherein said list of realm specific addresses starts with an address from the root address realm, followed by an address of at least one interstitial function node connected to address realms that the data packet traverses, and ends with an address from an address realm to which a node is currently connected.
